(19) United States
(12) Patent Application Publication
(10) Pub. No.: US 2014/0081801 A1
(43) Pub. Date: Mar. 20, 2014

(54) USER TERMINAL DEVICE AND NETWORK SERVER APPARATUS FOR PROVIDING EVALUATION INFORMATION AND METHODS THEREOF

(71) Applicant: Samsung Electronics Co., Ltd., Suwon-si (KR)

(72) Inventors: Keum-koo LEE, Seongnam-si (KR); Sun CHOI, Seongnam-si (KR)

(73) Assignee: Samsung Electronics Co., Ltd., Suwon-si (KR)

(21) Appl. No.: 14/026,303

(22) Filed: Sep. 13, 2013

(30) Foreign Application Priority Data
Sep. 18, 2012 (KR) 10-2012-0103506

(51) Int. Cl. G06Q 30/02; G06F 17/30

(52) U.S. Cl. CPC G06Q 30/0282; G06F 17/30345
USPC 705/26.8; 707/803

(57) ABSTRACT

A network server apparatus is provided. The network server includes a storage unit configured to store a purchase list of a pre-registered user, a communicator configured to receive a list of products of interest of a first user, a searcher configured to compare a purchase list stored in the storage unit with the list of products of interest and identify a second user who has purchased a product recorded in the list of products of interest, and a controller configured to, when the second user is identified, notify that the second user is identified to a user terminal device of one of the second user and the first user.

### CROSS-REFERENCE TO RELATED APPLICATION(S)

This application claims the benefit under 35 U.S.C. §119(a) of a Korean patent application filed on Sep. 18, 2012 in the Korean Intellectual Property Office and assigned Serial No. 10-2012-0103506, the entire disclosure of which is hereby incorporated by reference.

### TECHNICAL FIELD

The present disclosure relates to a user terminal device and a network server apparatus for providing evaluation information and methods thereof. More particularly, the present disclosure relates to a user terminal device and a network server apparatus which provide evaluation information by sharing information regarding purchasing of products through network and methods thereof.

### BACKGROUND

With the development of electronic technology, various types of electronic apparatuses have been developed and distributed. Accordingly, methods to allow users to use various electronic apparatuses more efficiently have been searched continuously.

One of the most representative methods is Internet shopping technology which allows users to purchase products through the Internet. In the past, users usually visit a shopping mall and obtain information regarding a desired product before purchasing the product. Recently, users may check information regarding a desired product by connecting to a shopping mall through a web page via Internet and make direct payment.

By using such Internet shopping technology, vendors may save money by not operating a store in a shopping mall, and users may also save time and money as they do not need to visit the shopping mall in person.

However, when users do order goods through the Internet, they may check information regarding products only through a web page and thus, it is difficult to evaluate the products precisely. In many cases, users end up being disappointed about the products which they purchased through Internet shopping as the products have lower quality than expected.

Therefore, a technology for providing evaluation information to help users make more precise decision regarding products before purchasing them is required.

The above information is presented as background information only to assist with an understanding of the present disclosure. No determination has been made, and no assertion is made, as to whether any of the above might be applicable as prior art with regard to the present disclosure.

### SUMMARY

Aspects of the present disclosure are to address at least the above-mentioned problems and/or disadvantages and to provide at least the advantages described below. Accordingly, an aspect of the present disclosure is to provide a user terminal device and a network server apparatus which provide evaluation information regarding a product from other users to help the user make a better decision regarding purchasing of a product and a method for providing evaluation information thereof.

In accordance with an aspect of the present disclosure, a network server apparatus is provided. The apparatus includes a storage unit configured to store a purchase list of a pre-registered user, a communicator configured to receive a list of products of interest of a first user, a searcher configured to compare a purchase list stored in the storage unit with the list of products of interest and identify a second user who has purchased a product recorded in the list of products of interest, and a controller configured to, when the second user is identified, notify that the second user is searched to a user terminal device of one of the second user and the first user.

The controller, when evaluation information of the product is received from the terminal apparatus of the second user, may control the communicator to transmit the evaluation information to the terminal device of the first user.

The controller, when the second user is identified, may control the communicator to transmit a message signal inquiring whether to share information to the terminal device of the first user, when a signal to approve sharing of information is received from the terminal device of the first user, to transmit an alarm message to the terminal device of the second user, and when a signal to disapprove sharing of information is received from the terminal device of the first user or a signal to approve sharing of information is not received for a predetermined time, not to transmit the alarm message, and the alarm message may be a message to request an input of recommendation information of the product.

The controller, when the list of products of interest of the first user is received, may control the searcher to transmit a message signal inquiring sharing of information to the terminal device of the first user, and when a signal to approve sharing of information is transmitted from the terminal apparatus of the first user, to identify the second user.

The list of products of interest may be a list of information of products that are selected from different web pages.

The searcher may search users related to the first user from among all pre-registered users, and identifies the second user from among the searched related users.

The purchase list stored in the storage unit and the list of products of interest may be sharable among related users.

In accordance with another aspect of the present disclosure, a method for providing information in a network server apparatus is provided. The method includes receiving a list of products of interest of a first user, comparing a purchase list of a related user with the list of products of interest and identifying a second user who has purchased a product recorded in the list of products of interest, and when the second user is identified, notifying that the second user is identified to a user terminal device of one of the second user and the first user.

The method may further include, when evaluation information of the product is received from the terminal apparatus of the second user, transmitting the evaluation information to the terminal device of the first user.

The notifying may include transmitting a message signal inquiring whether to share information to the terminal device of the first user, and when a signal to approve sharing of information is received from the terminal device of the first user, transmitting an alarm message to the terminal device of the second user, and the alarm message may be a message to request an input of recommendation information of the product.

The method may further include, when the list of products of interest of the first user is received, transmitting a message signal inquiring sharing of information to the terminal device of the first user, and the second user may be searched when a signal to approve sharing of information is transmitted from the terminal apparatus of the first user.

The list of products of interest may be a list where information of products that are selected different web pages.

The identifying of the second user may include searching users related to the first user from among all pre-registered users and searching a purchase list including a product in the list of products of interest from purchase lists of the searched related users and determining a user corresponding to the searched purchase list as the second user.

The purchase list stored in the storage unit and the list of products of interest may be sharable among related users.

In accordance with another aspect of the present disclosure, a user terminal device is provided. The device includes a communicator configured to transmit information of a purchased product to a network server apparatus, and when the purchased product is included in a list of products of interest of another user, receive an alarm message from the network server apparatus, a display configured to display a User Interface (UI) to receive evaluation information of the purchased product when the alarm message is received, and a controller configured to, when the evaluation information is input on the UI, transmit the evaluation information to the network server apparatus.

In accordance with another aspect of the present disclosure, a method for providing evaluation information in a user terminal device is provided. The method includes transmitting information of a purchased product to a network server apparatus, when the purchased product is included in a list of products of interest of another user, receiving an alarm message from the network server apparatus, when the alarm message is received, displaying a UI to receive evaluation information of the purchased product, and when the evaluation information is input on the UI, transmitting the evaluation information to the network server apparatus.

In accordance with another aspect of the present disclosure, a user terminal device is provided. The device includes a communicator configured to receive a web page from a web server, a display configured to display the web page, and a controller configured to control the communicator to include a product selected on the web page in a list of products of interest and transmit the list to the communicator, and the controller, when evaluation information of another user who has purchased a product included in the list of products of interest is received from the network server apparatus, controls the display to display the evaluation information.

In accordance with another aspect of the present disclosure, a method for providing evaluation information in a user terminal device is provided. The method includes receiving a web page from a web server, displaying the web page, when a product is selected on the web page, including the selected product in a list of products of interest and transmitting the list to a network server apparatus, receiving evaluation information of another user who has purchased a product included in the list of products of interest from the network server apparatus, and displaying the evaluation information.

The method may include transmitting information of a product purchased by a user of the user terminal device to the network server apparatus, when an alarm message informing that there is a list of products of interest including the purchased product is received from the network server apparatus, displaying a UI to receive evaluation information of the purchased product, and when the evaluation information is input on the UI, transmitting the evaluation information to the network server apparatus.

In accordance with another aspect of the present disclosure, a database server is provided. The server includes a communicator configured to perform communication with an external apparatus, a storage unit configured to store a purchase history of a pre-registered user, and an update unit configured to, when purchase information of the pre-registered user is received from the external apparatus, update the stored purchased history based on the received purchase information.

As such, according to various embodiments, a user may be provided with accurate evaluation information from another user who has purchased a product and thus, the user may make an informed decision as to whether to purchase the product.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a block diagram of a network system according to an embodiment of the present disclosure;

FIG. 2 illustrates an operation of the network system of FIG. 1 according to an embodiment of the present disclosure;

FIG. 3 is a block diagram of a network server apparatus 100 used in the network system of FIG. 1 according to an embodiment of the present disclosure;

FIG. 4A is a block diagram of a terminal devices used in the network system of FIG. 1 according to an embodiment of the present disclosure;

FIG. 4B is a more detailed block diagram of the terminal device of FIG. 4A according to an embodiment of the present disclosure;

FIG. 5 is a block diagram of software modules stored in a storage unit 260 according to an embodiment of the present disclosure;

FIGS. 6 and 7 are views provided to explain a method for providing a UI screen of a user terminal device according to various embodiments of the present disclosure;

FIG. 8 illustrates a UI screen when a menu from FIG. 6 is selected according to an embodiment of the present disclosure;

FIGS. 9 and 10 illustrate a UI screen when another menu FIG. 6 is selected according to an embodiment of the present disclosure;

FIG. 11 illustrates a UI screen when another menu from FIG. 6 is selected according to an embodiment of the present disclosure;

FIGS. 12A and 12B illustrate a method for storing information in an integrated wish-list according to an embodiment of the present disclosure;

FIG. 13 illustrates a method for storing information in an integrated wish-list according to another embodiment of the present disclosure;

FIGS. 14A and 14B illustrate a method for comparing lists according to an embodiment of the present disclosure;

FIG. 15 illustrates change of screen display status in a first user terminal device for selecting a product according to an embodiment of the present disclosure;

FIGS. 16A, 16B, 17A, 17B, and 18 illustrate example screens of the user terminal device according to various embodiments of the present disclosure;

FIG. 19 is a flowchart of a method for providing information in a network server apparatus according to an embodiment of the present disclosure;

FIG. 20 is a flowchart of a method for providing information in a network server apparatus according to an embodiment of the present disclosure;

FIG. 21 is a flowchart of a method for providing evaluation information regarding a product of interest of other users according to an embodiment of the present disclosure;

FIG. 22 is a flowchart of a method for receiving evaluation information from other users regarding a product of interest according to an embodiment of the present disclosure; and

FIG. 23 is a block diagram of a database server according to an embodiment of the present disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surface.

It should be observed the method steps and system components have been represented by conventional symbols in the figures, showing only specific details which are relevant for an understanding of the present disclosure. Further, details readily apparent to person ordinarily skilled in the art may not have been disclosed. In the present disclosure, relational terms such as first and second, and the like, may be used to distinguish one entity from another entity, without necessarily implying any actual relationship or order between such entities.

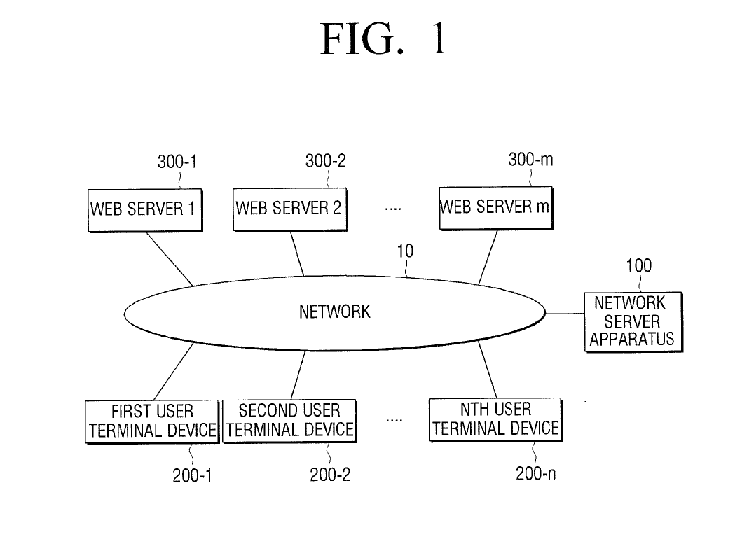

FIG. 1 is a block diagram of a network system according to an embodiment of the present disclosure.

Referring to FIG. 1, the network system comprises a plurality of user terminal devices 200-1˜200-n which are connected to each other via network 10, a plurality of web servers 300-1˜300-m, and a network server apparatus 100.

The user terminal devices 200-1˜200-n may be realized as various types of apparatuses such as a Personal Computer (PC), notebook PC, tablet PC, mobile phone, Personal Digital Assistant (PDA), and so on. Each of the web servers 300-1˜300-n may be realized as a server for operating various types of on-line shopping malls.

A user may connect to the web servers 300-1˜300-n using his or her user terminal device. Specifically, after executing a web browser program, the user may connect to the web servers 300-1˜300-n by inputting a Uniform Resource Locator (URL) corresponding to each of the web servers 300-1˜300-n or selecting a link to the web servers 300-1˜300-n.

When a user terminal device is connected, each of the web servers 300-1˜300-n provide a web page where products are being sold in the corresponding web server. In addition, a menu for registering a certain product as a product of interest may also be displayed on the web page. Each of the user terminal devices 200-1˜200-n display the web pages.

A user may select a desired product on the web page that is displayed on the user terminal device. When the user selects a product, the user terminal device may display additional description of the product. The additional description may include detailed information of the product such as enlarged image, a price, a size, and the type of the product. In addition, the user may select a purchase button to purchase the product.

However, when it is difficult for a user to make a decision to purchase, the product may be registered as a product of interest. In this case, the user may select a menu for registering the product as a product of interest. Herein, the menus that the user may select include a wish-list menu, a cart menu, and so on. The wish-list menu allows the user to store a product code and option information for a relatively long period of time. The cart menu allows the user to store information regarding a product for a relatively shorter period of time, and allows the user to edit options such as the quantity to be purchased. There is difference between the wish-list and the cart, however, in that when a product is sold out, the product can be included in the wish-list, but cannot be included in the cart. Depending on the web page, both the wish-list menu and the cart menu may be provided, or only one of them may be provided. In this embodiment, a menu which allows users to store information of a selected product and check the selected product later, such as the wish-list menu and the cart menu, will be referred to as a menu for registering a product of interest, the product registered through the menu will be referred to as a product of interest, and the list thereof will be referred to as a list of products of interest.

When a user selects a product and selects the menu for registering a product of interest, information of the selected product is included in the list of products of interest. The list is transmitted to the network server apparatus 100. Specifically, i) the list may be produced by the user terminal device and transmitted to the network server apparatus 100, or ii) information of a selected product may be transmitted to the network server apparatus 100 whenever the selection is made, and the network server apparatus 100 may request the web server to send information of the selected product and receive the information from the web server. Alternatively, iii) when a user selects a product, the web server may transmit information of the product directly to the network server apparatus 100.

When a list of products of interest is received, the network server apparatus 100 compares the list with a pre-stored purchase list of other users to check whether any users have purchased the products included in the list of products of interest. When it is determined that there is a user who made such a purchase, the network server apparatus 100 may provide an alarm message. Herein, the purchase list may include information of whether a product is purchased, when it is purchased, how it is purchased, how much it is, and so on.

Depending on various embodiments, the network server apparatus 100 may provide an alarm message to at least one of a user who has selected a corresponding product as a product of interest and other users who have purchased the corresponding product. For example, an alarm message may be transmitted to either a user who has selected the corresponding product or other users who have purchased the corresponding product, or to both. The alarm message may be realized and transmitted in various ways. For example, an alarm message may be provided in the form of a text message, an e-mail, an instant messenger service, and so on. The transmission method may vary depending on the relationship between the users.

Meanwhile, when an alarm message is provided to other users who have purchased the corresponding product, other users may provide evaluation information of the corresponding product to the network server apparatus 100 by inputting the evaluation information through their user terminal device. The evaluation information is related to whether the corresponding product is recommended for purchase, information related to the quality of the corresponding product, and so on. A method for providing the evaluation information will be described later.

Referring to FIG. 1, the network server apparatus 100 may be realized as a Social Network Service (SNS) server apparatus. The SNS refers to an online platform where users may communicate, share information, and create and strengthen social relationships by extending personal connections. When the network server apparatus 100 is realized as an SNS server apparatus, the network server apparatus 100 may transmit and receive the alarm message or the evaluation information to and from users having a social network relationship. In addition, the network server apparatus 100 may be realized as a shopping mall server, a messenger server, etc., or may be realized as a separate server for providing a corresponding service.

Meanwhile, a user may also check a plurality of web pages sequentially. In addition, a user may register a product of each web page as a product of interest. Specifically, a user may register a product on a web page provided by the first web server 300-1 as a product of interest, and register another product one a web page provided by the second web server 300-2 as a product of interest.

In this case, according to an improved embodiment, products selected from each web page may be registered in one list of products of interest and provided to the network server apparatus 100. In this embodiment, a list including information of products which are registered as products of interest in other web pages in an integral manner is referred to as an integrated wish-list. When an integrated wish-list is received, the network server apparatus 100 may also compare the list with a pre-stored purchase list to find a corresponding purchaser. When it is determined that there is the corresponding purchaser, network server apparatus 100 may notify one of a user who created the integrated wish-list and the purchaser.

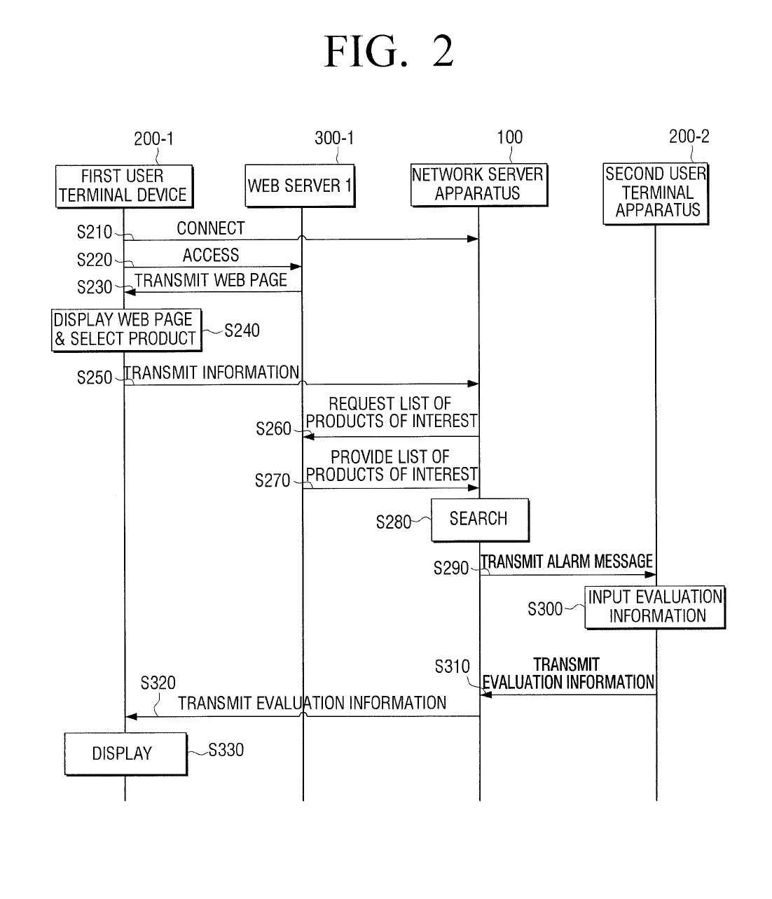

FIG. 2 illustrates an operation of the network system of FIG. 1 according to an embodiment of the present disclosure.

Specifically, an embodiment where a user of the first user terminal device 200-1 registers a product of interest and a user of the second user terminal device 200-2 evaluates the product of interest will be explained.

Referring to FIG. 2, the first user terminal device 200-1 initially connects to the network server apparatus 100 at operation S210. When the network server apparatus 100 is realized as an SNS server apparatus, a user of the first user terminal device 200-1 may connect to the network server apparatus 100 by inputting a URL, etc., and then, may log onto the network server apparatus 100 by inputting a user ID, a pin number, and so on.

In this state, when the user accesses the first web server 300-1 through the first user terminal device 200-1 at operation S220, the first web server 300-1 transmits a web page at operation S230. The first user terminal device 200-1 displays a web page, and the user may select a product on the web page at operation S240.

When a product is selected, the first user terminal device 200-1 transmits information regarding the selected product to the network server apparatus 100 at operation S250.

When the information of the selected product is transmitted, the network server apparatus 100 requests the first web server 300-1 to send a list of products of interest at operation S260. The list of products of interest may be a wish-list or a cart list as described above. In response to the request, the first web server 300-1 transmits the list of products of interest to the network server apparatus 100 at operation S270.

Subsequently, the network server apparatus 100 compares a pre-stored user purchase list with the received list of products of interest to search a second user who has purchased the product at operation S280.

When the second user is searched in S280, an alarm message informing the search is transmitted to the user terminal device of the second user, that is, the second user terminal device 200-2 at operation S290. That is, an alarm message informing that the product on the list of products of interest is on the purchase list of the second user may be transmitted to the second user terminal device 200-2. However, in other examples, the corresponding message may be transmitted to the first user terminal device 200-1 so that the first user requests the second user to send evaluation information of the corresponding product.

Subsequently, when the evaluation information regarding the corresponding product is input from the second user terminal device at operation S300, the evaluation information is transmitted to the network server apparatus 100 at operation S310. In this case, the network server apparatus 100 transmits the received evaluation information to the first user terminal device 200-1 at operation S320.

The first user terminal device 200-1 may receive and display the corresponding evaluation information at operation S330.

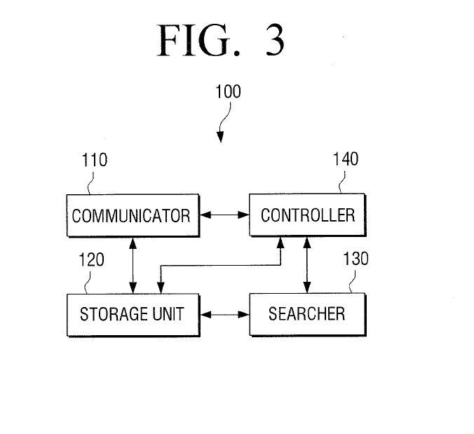

FIG. 3 is a block diagram of a network server apparatus 100 used in the network system of FIG. 1 according to an embodiment of the present disclosure.

Referring to FIG. 3, the network server apparatus 100 comprises a communicator 110, a storage unit 120, a searcher 130, and a controller 140.

The communicator 110 performs communication with apparatuses which are connected via the network 10. The communicator 110 may receive a list of products of interest of other users. In this embodiment, a user who writes a list of products of interest will be referred to as the first user for convenience of explanation. Depending on various embodiments, the subject that transmits a list of products of interest may vary. For example, the communicator 110 may receive a list of products of interest of the first user directly from the user terminal device of the first user, or may receive the list from a web server. When the list is received from the web server, the communicator 110 may receive product information and web server information of a product selected from the user terminal device of the first user, and then may receive detailed information of the corresponding product by accessing the web server using the received web server information.

The storage unit 120 stores a purchase list of a user. The purchase list refers to a list of products which have been purchased by users that are registered in the network server apparatus 100. In addition, the storage unit 120 may store a list of products of interest of registered users.

When the list of products of interest is received, the searcher 130 compares the list of products of interest with a purchase list stored in the storage unit 120 to search for a user who has purchased a product on the list of products of interest. In this embodiment, a user who has purchased a product on the list of products of interest will be referred to as the second user for convenience of explanation.

Meanwhile, the second user may be searched within a specific scope of users. For example, the second user may be searched among acquaintances of the first user. Herein, the acquaintances may be users who have a certain relationship with the first user on network, and may be users who belong to the scope of acquaintances on SNS. Alternatively, when the network apparatus 100 has a phone book list of the first user, the users included in the phone book list of the first user may belong to the scope of acquaintances.

However, the second user is not limited to the above scope, and may include users who have authorized as reliable are not acquaintances of the first user. For example, the second user may be users who have authorized as reliable include a power reviewer and a power blogger.

When the second user is searched, the controller 140 notifies the same to the user terminal device of at least one of the second user and the first user.

Specifically, the controller 140 may transmit an alarm message inquiring whether to provide evaluation information regarding a corresponding product to the second user. In addition, the controller 140 may transmit an alarm message informing that the second user has purchased the corresponding product to the user terminal device of the first user. Accordingly, the second user may transmit evaluation information of the corresponding product to the first user, and the first user may request the second user to send the evaluation information regarding the corresponding product.

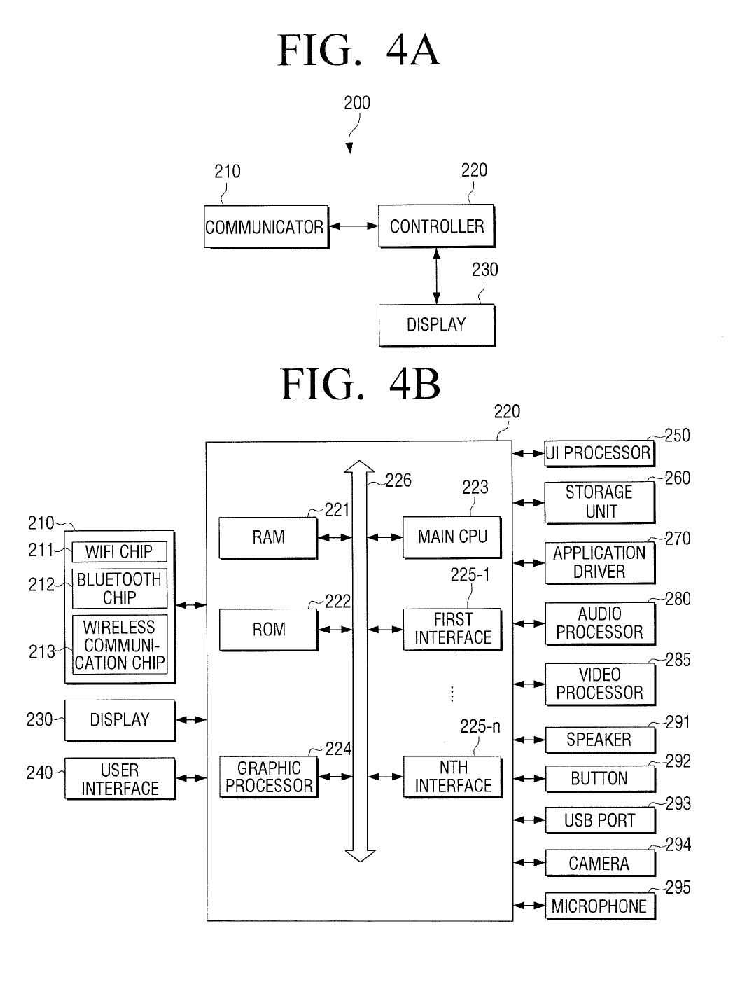

FIG. 4A is a block diagram of a terminal devices used in the network system of FIG. 1 according to an embodiment of the present disclosure.

Referring to FIG. 4A, the user terminal device 200 comprises a communicator 210, a controller 220, and a display 230. In the embodiment illustrated in FIG. 2, both the first user terminal device 200-1, which selects a product of interest, and the second user terminal device 200-2, which provides evaluation information, may have the configuration illustrated in FIG. 4A. Accordingly, the configuration of FIG. 4A will be divided into two cases and explained below.

First, a case where the first terminal device 200-1, which selects a product of interest is configured in the form of FIG. 4A, will be explained.

The communicator 210 receives a web page from a web server. The address information to specify a web server, such as a URL, may be input through an input means (not shown) on the first user terminal device 200-1 such as button, touch screen, touch pad, and so on, or through a voice recognition module (not shown) or a motion recognition module (not shown).

When a web page is received through the communicator 210, the display 230 displays the web page. A user may select a product on the web page. A user may select a product through the input methods described above, or through a voice recognition module and a motion recognition module.

The controller 220 may control the communicator 210 to include the product selected on the web page in a list of products of interest and transmit the same to a network server apparatus. The list of products of interest may be an integrated wish-list which includes information of products selected from a plurality of different web pages in an integral manner, but is not limited thereto, and the products selected from each web page may be managed separately.

As described above, when the list of products of interest is received, the network server apparatus 100 compares the list with a purchase list to search other users who have purchased products included in the list of products of interest. When it is determined that there is such a user, evaluation information may be requested and provided from the user. The network server apparatus 100 may transmit the evaluation information provided by the user to the communicator 210.

When the evaluation information of the user who has purchased a product included in the integrated wish-list is received from the network server apparatus 100, the controller 220 controls the display 230 to display the evaluation information. The user may decide whether to purchase the product included in the list of products of interest based on the displayed evaluation information.

However, in some cases, in other examples, the first user terminal device 200-1 may search for other users who have purchased products included in the list of products of interest. For example, when there is a database server which manages the purchase history of other users, the first user terminal device 200-1 may directly search the database server. For example, it is possible for the first user terminal device 200-1 to search the database server through a user input or an automatic input using an input device provided by the user terminal device 200-1 (e.g., a keyboard). Herein, the purchase history may include a product that was purchased, when it is purchased, how it is purchased, how much it is, and so on. In addition, the database server may include the purchase history and the relationship among users. Accordingly, it is possible to search only users who have a certain relation with a user who is logged in.

Further, when evaluation information of another user is received from the network server apparatus 100, the display 230 may display the evaluation information. Accordingly, a user may refer to the evaluation information of another user when deciding to purchase a product included in the list of products of interest.

Subsequently, a case where the second user terminal device 200-2 which transmits evaluation information is configured in the form of FIG. 4A will be explained.

The communicator 210 transmits information of a product which the second user has purchased to the network server apparatus 100.

In addition, when a purchased product is included in an integrated wish-list of another user, the communicator 210 receives an alarm message from the network server apparatus 100. Specifically, the communicator 210 may receive an alarm message informing that the corresponding purchased product is included in the list of products of interest of the first user and inquiring whether to provide the evaluation information of the corresponding product to the first user.

When the alarm message is received, the display 230 displays a User Interface (UI) to input evaluation information of the purchased product. For example, the display may display a UI inquiring whether to recommend the corresponding product or a UI inquiring whether to input evaluation regarding the corresponding product.

In addition, the display 230 may list and display various evaluation methods, and receive evaluation information according to an evaluation method which is selected according to a user command. Herein, the evaluation method may include a method for checking preset items or a method for writing evaluation directly.

Further, the display 230 may list and display methods for transmitting evaluation information, and receive evaluation information according to a transmission method which is selected according to a user command. Herein, the transmission method may include a text message, an instant messenger, an e-mail, and so on.

When evaluation information is input on the UI provided by the display 230, the controller 220 may control the communicator 210 to transmit the evaluation information to the network server apparatus 100.

FIG. 4B is a more detailed block diagram of the terminal device of FIG. 4A according to an embodiment of the present disclosure.

Referring to FIG. 4B, the user terminal device 200 comprises the communicator 210, the controller 220, the display 230, a user interface 240, a UI processor 250, a storage unit 260, an application driver 270, an audio processor 280, a video processor 285, a speaker 291, a button 292, a USB port 293, a camera 294, and a microphone 295. The elements of FIG. 4B which are overlapped with those illustrated in FIG. 4A will not be described in detail.

The communicator 210 is an element which performs communication with various types of external apparatuses according to various communication methods. The communicator 220 may include various communication chips such as a Wireless Fidelity (WiFi) chip 211, a Bluetooth® chip 212, a wireless communication chip 213, and so on. The WiFi chip 211 and the Bluetooth chip 212 perform communication according to a WiFi method and a Bluetooth® method, respectively. The wireless communication 213 chip performs communication according to various communication standards such as Zigbee®, 3rd Generation (3G), 3rd Generation Partnership Project (3GPP), Long Term Evolution (LTE), and so on. In addition, the communicator 210 may further include an Near Field Communication (NFC) chip which operates according to a NFC method by using bandwidth from various RF-ID frequency bands such as 135 kHz, 13.56 MHz, 433 MHz, 860-960 MHz, 2.45 GHz, and so on.

The operation of the controller 220 may be performed by a program stored in the storage unit 260. The storage unit 260 may include various data such as data which is input or set while an Operating System (O/S) software module and various applications are executed, contents, and so on.

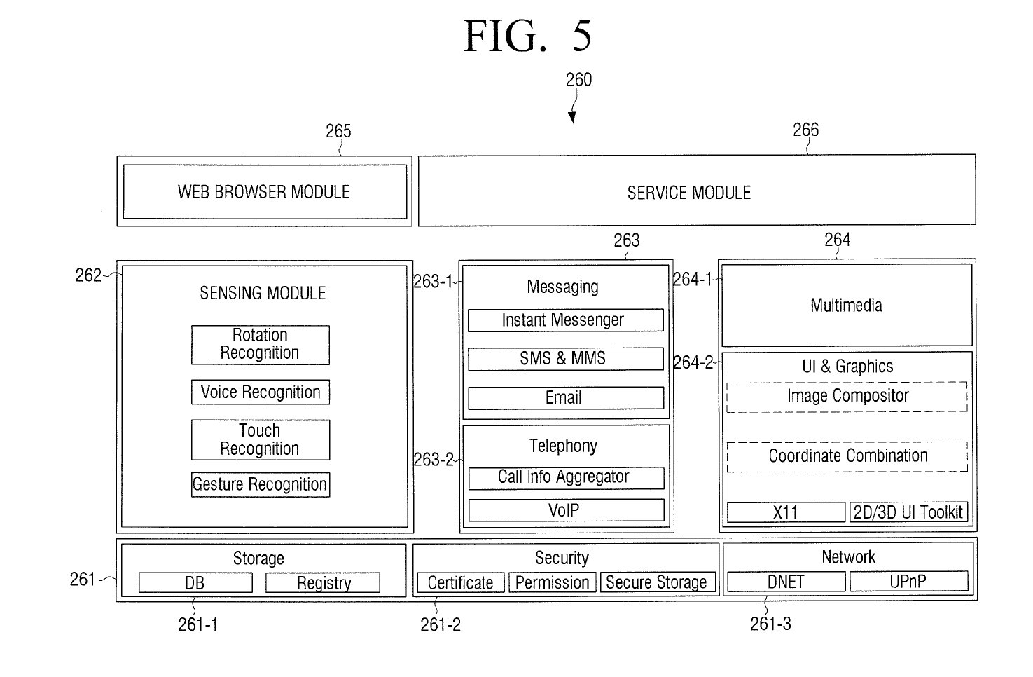

Other software modules which are stored in the storage unit 260 will be described later with reference to FIG. 5.

The user interface 240 is an input means to receive and transmit a user command to the controller 220, and may be realized as an input panel. Herein, the input panel may be realized as a touch pad, a key pad including various function keys, number keys, special keys, text keys, etc., or a touch screen.

Specifically, the user interface 240 may receive various user commands to be provided with an integrated wish-list service. For example, the user interface 240 may receive a user command to drive or terminate an integrated wish-list application and a user command to manipulate various UI screens associated with the integrated wish-list service.

The UI processor 250 may generate various types of Graphical UIs (GUIs).

In addition, the UI processor 250 may process and generate various UI screens in 2D or 3D form. Herein, the UI screen may be a screen which is associated with the execution of the integrated wish-list application as described above. In addition, the UI screen may be a screen which displays text or diagrams such as a menu screen, a warning sentence, a time, a channel number, etc.

Further, the UI processor 250 may perform operations such as 2D/3D conversion of UI elements, adjustment of transparency, color, size, shape, and location, highlights, animation effects, and so on.

For example, the UI processor 250 may process a wish-list icon displayed on the screen in various ways as described above.

The storage unit 260 is a storage medium where various programs necessary to operate the user terminal device 200 are stored, and may be realized as a memory, a Hard Disk Drive (HDD), and so on. For example, the storage unit 260 may comprise a Read Only Memory (ROM) for storing programs to perform operations of the controller 220, a Random Access Memory (RAM) for temporarily storing data regarding operations of the controller 220, and so on. In addition, the storage unit 260 may further comprise Electrically Erasable and Programmable ROM (EEPROM) for storing various reference data.

In particular, the storage unit 260 may store an integrated wish-list application, and in some cases, may store some information associated with an integrated wish-list service.

For example, the information associated with an integrated wish-list service may be stored and managed through the network server apparatus 100, but frequently used information of a corresponding application may be stored and managed in the storage unit 260. For example, UI layout information regarding the corresponding application, product information which is recorded frequently through the integrated wish-list, etc., may be managed through the storage unit 260.

The application driver 270 drives and executes an application which can be provided by the user terminal device 200. Herein, the application refers to an application program which is executable and may include various multimedia contents. Herein, the term, ‘multimedia contents’, include text, audio, a still image, an animation, video, interactive contents, Electronic Program Guide (EPG) contents from content providers, electronic messages received from users, information regarding current events, etc., but is not limited thereto.

The audio processor 280 is configured to process audio data. The audio processor 280 may perform various processing with respect to audio data such as decoding, amplification, noise filtering, and so on.

The video processor 285 is configured to process video data. The video pre-processor 285 may perform various processing with respect to video data such as decoding, scaling, noise filtering, frame rate conversion, resolution conversion, and so on.

The speaker 291 outputs various audio data processed by the audio processor 280, various alarm sounds, and voice messages.

The button 292 may be configured in various ways such as mechanical button, touch pad, wheel, etc., which are formed on a certain area of the user terminal device 200, such as on the front, side, or rear of the external surface of the main body. For example, a button to turn on/off the power of the user terminal device 200 may be provided on a side.

The USB port 293 may perform communication with various external apparatuses through a USB cable or perform recharging.

The camera 294 may photograph a still image or a moving image under the control of a user. The camera 294 may consist of a plurality of cameras such as a front camera and rear camera.

The microphone 295 receives a user voice or other sounds and converts the same to audio data. The controller 220 may use a user voice input through the microphone 295 during a call, or may convert the user voice into audio data and store the same in the storage unit 260.

When the camera 294 and the microphone 295 are provided, the controller 220 may perform a control operation according to a user voice input through the microphone 295 or a user motion recognized by the camera 294. That is, the user terminal device 200 may operate in a motion control mode or a voice control mode. When the user terminal device 200 operates in the motion control mode, the controller 220 photographs a user by activating the camera 294, determines a user motion is provided, and performs a corresponding control operation. When the user terminal device 200 operates in the voice control mode, the controller 220 analyzes a user voice input through the microphone and performs a control operation according to the analyzed user voice.

In addition, various external input ports are provided to connect to various external terminals such as a headset, a mouse, a Local Area Network (LAN), etc., may be further included.

Meanwhile, the controller 220 controls overall operations of the user terminal device 200 using various programs stored in the storage unit 260.

For example, the controller 220 may execute an application stored in the storage unit 260, and configure and display a screen for execution of the application, or may reproduce various contents stored in the storage unit 260. In addition, the controller 220 may perform communication with external apparatuses through the communicator 210.

Specifically, the controller 220 comprises an RAM 221, a ROM 222, a main CPU 223, a graphic processor 224, a first to nth interfaces 225-1˜225-n, and a bus 226.

The RAM 221, the ROM 222, the main CPU 223, the graphic processor 224, and the first to nth interfaces 225-1˜225-n may be connected to each other through a bus 226.

The first to nth interfaces 225-1˜225-n are connected to the above-described various components. One of the interfaces may be a network interface which is connected to an external apparatus via the network.

The main CPU 223 accesses the storage unit 260 and performs a booting process by executing the O/S stored in the storage unit 260, and performs various operations using various programs, contents, and data stored in the storage unit 260.

The ROM 222 stores a set of commands for system booting. If a turn-on command is input and power is supplied, the main CPU 223 copies an O/S stored in the storage unit 260 onto the RAM 221 according to a command stored in the ROM 222 and boots a system by executing the O/S. If the booting is completed, the main CPU 223 copies various application programs stored in the storage unit 260 onto the RAM 221 and performs the various operations by executing the application programs copied in the RAM 221.

The graphic processor 224 generates a screen including various objects such as an icon, an image, and a text using a computing unit (not shown) and a rendering unit (not shown). The computing unit computes property values such as coordinates, shape, size, and color of each object to be displayed according to the layout of the screen using input from the user. The rendering unit generates a screen with various layouts including objects based on the property values computed by the computing unit. The screen generated by the rendering unit is displayed within the display area of the display 230.

Albeit not illustrated in the drawing, the user terminal device 200 may further comprise a sensor (not shown).

The sensor (not shown) may sense various manipulations such as touch, rotation, tilt, pressure, approach, etc. with respect to the user terminal device 200. In particular, the sensor (not shown) may include a touch sensor which senses a touch. The touch sensor may be realized as capacitive or resistive sensor. The capacitive sensor calculates a touch coordinates by sensing micro-electricity provided when part of the user body touches the surface of the display 230 using a dielectric coated on the surface of the display 230. The resistive sensor comprises two electrode plates, and, when a user touches the screen, calculates a touch coordinates as the upper and lower plates contact with each other to sense flowing electric current. As such, a touch sensor may be realized in various forms. In addition, the sensor may further comprise a geomagnetic sensor to sense a rotation and a motion of the user terminal device 200 and an acceleration sensor to sense the degree of tilt of the user terminal device 200.

Although FIG. 4B illustrates an example of specific elements included in the user terminal device 200, but depending on exemplary embodiments, some of the elements illustrated in FIG. 4B may be omitted or changed, or other elements may be added. For example, a Global Positioning System (GPS) receiver (not shown) to receive a GPS signal from GPS satellite and calculate the current location of the user terminal device 100, and a Digital Multimedia Broadcasting (DMB) receiver (not shown) to receive and process a DMB signal may be further included.

FIG. 5 is a block diagram of software modules in a storage unit 260 according to an embodiment of the present disclosure.

Referring to FIG. 5, the storage unit 260 may store software including a base module 261, a sensing module 262, a communication module 263, a presentation module 264, a web browser module 265, and a service module 266.

The base module 261 refers to a basic module which processes a signal transmitted from hardware included in the user terminal device 100 and transmits the processed signal to an upper layer module. The base module 261 includes a storage module 261-1, a security module 261-2, and a network module 261-3. The storage module 261-1 is a program module including database or registry. The main CPU 223 may access a database in the storage unit 260 using the storage module 261-1 to read out various data. The security module 261-2 is a program module which supports certification, permission, secure storage, etc. with respect to hardware, and the network module 261-3 is a module which supports network connections, and includes a DNET module, a Universal Plug and Play (UPnP) module, and so on.

The sensing module 262 is a module which collects information from various sensors, and analyzes and manages the collected information. The sensing module 262 may include a face recognition module, a voice recognition module, a touch recognition module, a motion recognition (i.e., gesture recognition) module, a rotation recognition module, and an NFC recognition module, and so on.

The communication module 263 is a module to perform communication with other devices. The communication module 263 may include a messaging module 263-1 such as a messenger program, a Short Message Service (SMS) & a Multimedia Message Service (MMS) program, an e-mail program, etc., and a call module 263-2 including a call info aggregator program module, a VoIP module, etc.

The presentation module 264 is a module to compose a display screen. The presentation module 264 includes a multimedia module 264-1 for reproducing and outputting multimedia content and a UI rendering module 264-2 for UI and graphic processing. The multimedia module 264-1 may include a player module, a camcorder module, a sound processing module, and so on, thereby performing the operations of generating and reproducing various multimedia contents, screens, and sounds. The UI rendering module 264-2 may include an image compositor module for combining images, a coordinates combination module for combining and generating coordinates on the screen where an image is to be displayed, an X11 module for receiving various events from hardware, a 2D/3D UI toolkit for providing a tool for composing a UI in 2D or 3D form, and so on.

The web browser module 265 refers accesses a web server by performing web-browsing. The web browser module 265 may include various modules such as a web view module for composing a web page, a download agent module for downloading, a bookmark module, a web-kit module, and so on.

The service module 266 is a module including various applications for providing various services. Specifically, the service module 266 may include various program modules such as a navigation program, a content reproduction program, a game program, an electronic book program, a calendar program, an alarm management program, other widgets, and so on.

FIG. 5 illustrates various program modules, but some of the various program modules may be omitted, changed, or added according to the type and attribute of the user terminal device 100 according to an embodiment of the present disclosure. For example, a location-based module which supports a location-based service in association with hardware such as a GPS receiver may be further included.

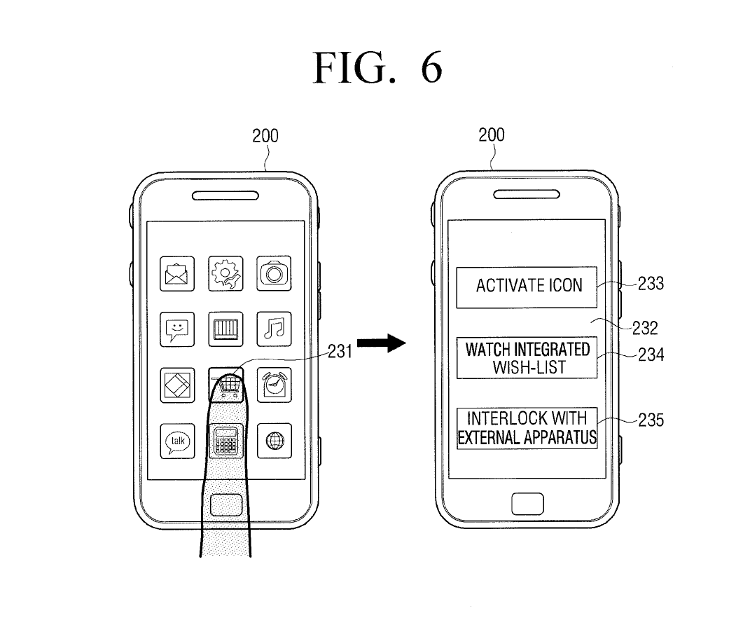

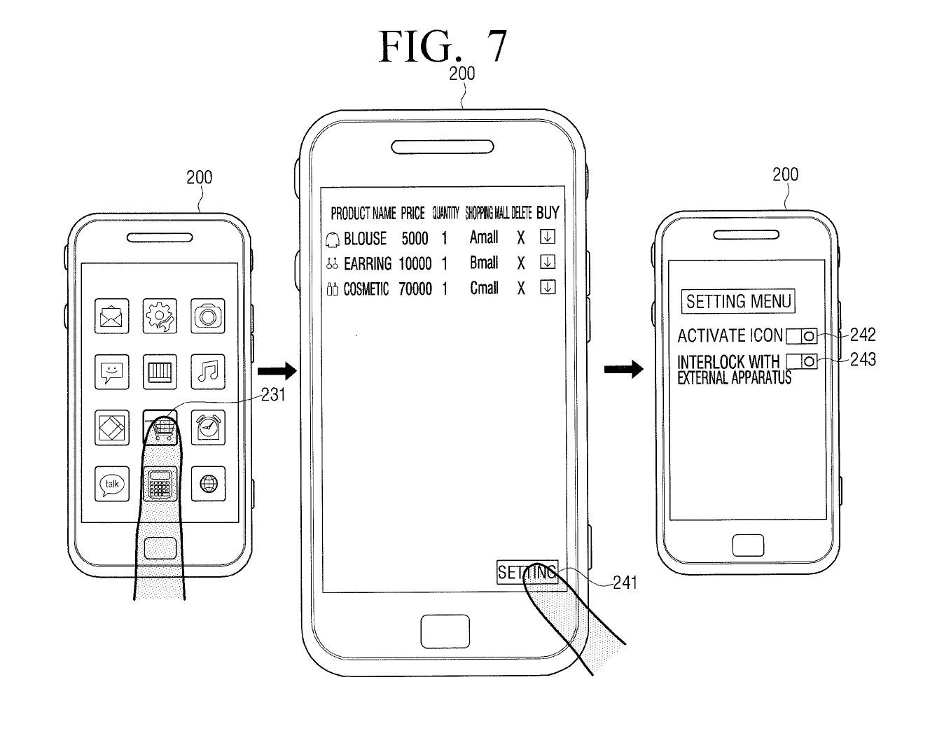

FIGS. 6 and 7 are views provided to explain a method for providing a UI screen of a user terminal device according to various embodiments of the present disclosure.

Referring to FIG. 6, an application to provide a wish-list service (hereinafter, referred to as an integrated wish-list application) according to an embodiment may be provided in the form of an icon 231. Herein, the 231 icon may be configured in the form of cart, but is not limited thereto.

As illustrated in FIG. 6, when the icon 231 corresponding to the integrated wish-list application is selected, a menu 232 of an integrated wish-list service may be displayed.

For example, the menu 232 of the integrated wish-list service may include a menu to activate icon 233, a menu to watch integrated wish-list 234, a menu to “interlock with external apparatus” 235, and so on.

However, this is only an example, and according to another embodiment, the function of activating an icon or the function of interlocking with an external apparatus may be automatically performed.

Further, when an application is manipulated again while the application is activated or the application is interlocked with an external apparatus, the integrated wish-list may be displayed automatically.

Referring to FIG. 7, when the icon 231 corresponding to the integrated wish-list application is selected, the list of objects recorded in the integrated wish-list may be displayed.

In this case, a separate setting button 241 is displayed, and when the setting button is selected, menus 242 and 243 may be provided to select whether to activate the function of activating an icon and the function of interlocking with an external apparatus. As illustrated in FIG. 7, when the icon activating function menu 242 and the external apparatus interlocking function menu 243 are inactivated, the corresponding functions may not be performed even though the application is operated. On the contrary, when the icon activating function menu 242 and the external apparatus interlocking function menu 243 are activated, the corresponding functions may be activated at the same time when the application is operated.

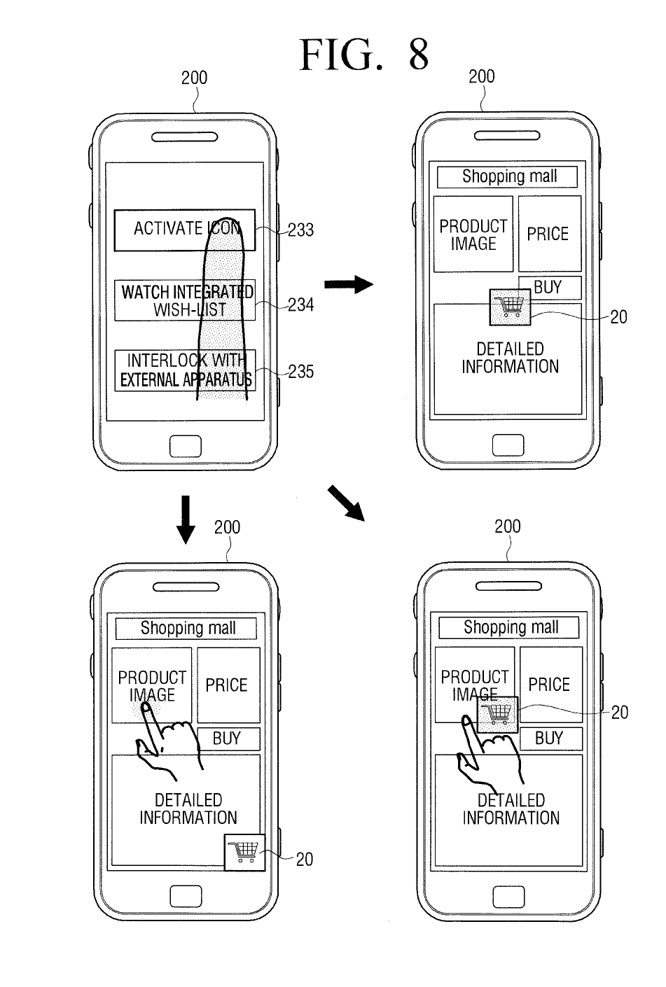

FIG. 8 illustrates a UI screen when a menu from FIG. 6 is selected according to an embodiment of the present disclosure.

Referring to the upper left portion of FIG. 8, when the activate icon menu 233 is selected, a wish-list icon may be activated and displayed on a shopping mall web page.

For example, as illustrated in the lower left portion of FIG. 8, a wish-list icon 20 may be displayed on one side of the screen where the shopping mall web page is displayed. In this case, a product image or product information may be touched and dragged to the wish-list icon 20, or the corresponding product may be added to the integrated wish-list through a touch-and-flick manipulation as illustrated in FIG. 8.

Alternatively, as illustrated in the upper right portion of FIG. 8, the wish-list icon 20 in the semitransparent form may be displayed on a different layer of the web page as if the icon is floating on the web page. In this case, an object may be added to the integrated wish-list through touching and holding the corresponding wish-list icon on the product image or the product information. Herein, a user may move the display location of the wish-list icon 20 through a touch-and-drag manipulation.

Further, as illustrated in the lower right portion of FIG. 8, the wish-list icon 20 may be interlocked with a user touch point and displayed on one side of the touch point. In this case, an object may be added to the integrated wish-list through the manipulation of touching and holding the corresponding wish-list icon on the product image or the product information. For example, at least one of the shape and color of the wish-list icon may be changed at the time of a touch and hold manipulation, and the corresponding product may be added to the integrated wish-list at the time of a swipe operation while at least one of the shape and color of the wish-list icon is changed.

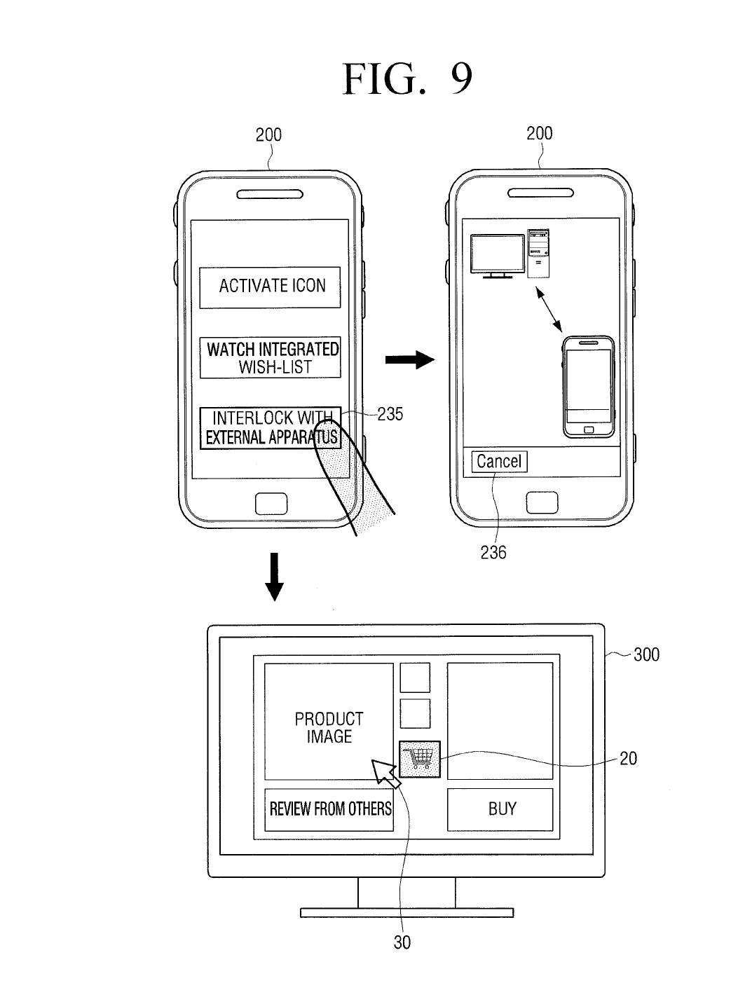

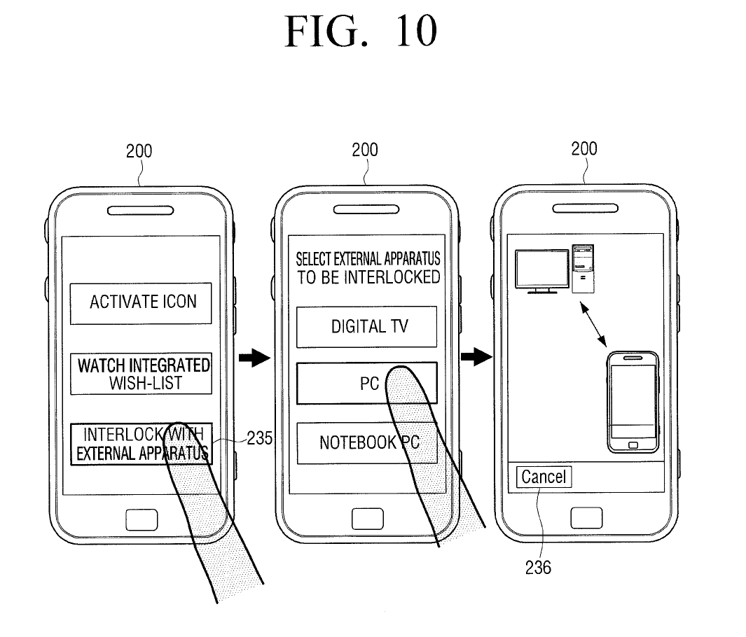

FIGS. 9 and 10 illustrate a UI screen when another menu FIG. 6 is selected according to an embodiment of the present disclosure.

Referring to the left portion of FIG. 9, when the interlock with an external apparatus menu 235 is selected, a wish-list icon may be activated and displayed on a shopping mall web page that is displayed on the screen of a display apparatus 300.

For example, the wish-list icon 20 may be interlocked with a cursor 30 displayed on the display apparatus 300, and may be displayed on one side of the cursor 30. When the display location of the cursor 30 moves, the wish-list icon 20 may track and display the wish-list icon 20.

In this case, an object may be added to the integrated wish-list through a touch and hold manipulation on a product image or product information. For example, at least one of the shape and color of the wish-list icon 20 may be changed when the cursor is displaced over an object which can be included in the integrated wish-list, such as a product image and product information, and the corresponding product may be added to the integrated wish-list as it is clicked or double-clicked while one of the shape and color of the cursor is changed.

Meanwhile, as illustrated in the upper right portion of FIG. 9, a screen indicating that an external apparatus is interlocked may be displayed on the user terminal device 200.

Referring to FIG. 10, when the menu 235 to “interlock with an external apparatus” is selected, the user terminal device 200 may search an external apparatus which is capable of performing communication and display a list of searched external apparatuses.

Subsequently, when a PC is selected on the menu as an external apparatus to be interlocked, a UI screen indicating that the user terminal device 200 is interlocked with the external display apparatus 300 may be displayed. In this case, a cancel button 236 may be used to release the interlocking between the user terminal device 200 and the external display apparatus 300.

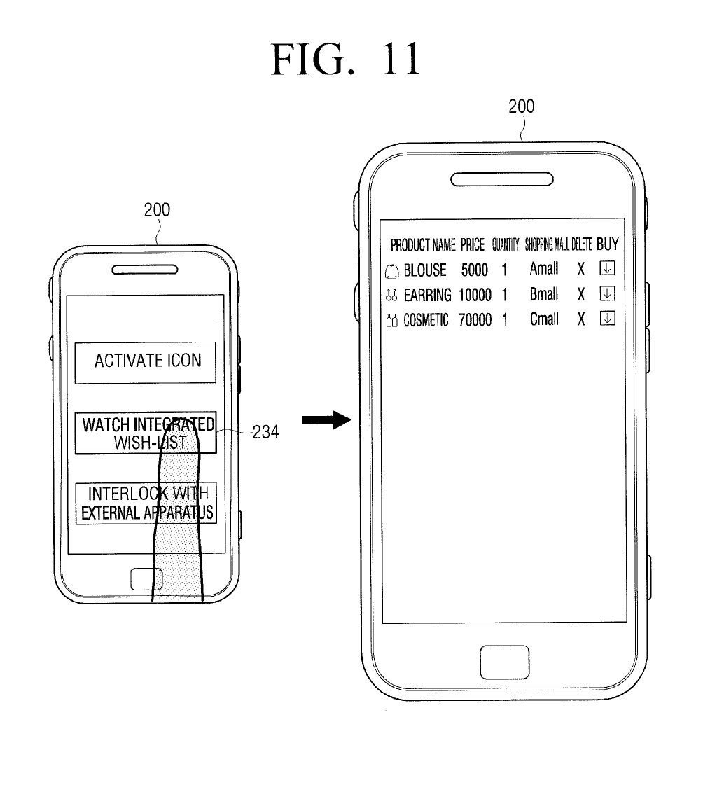

FIG. 11 illustrates a UI screen when another menu from FIG. 6 is selected according to an embodiment of the present disclosure.

Referring to FIG. 11, when the watch integrated wish-list menu 234 is selected, a list of objects recorded in the integrated wish-list may be displayed. As illustrated in the drawing, information corresponding to each object, for example, a product name, a price, a quantity, shopping mall information, etc. may be displayed, and a buy button, a cancel button, etc., may be provided. The watch integrated wish-list menu 234 may include suitable sub menus such as view in the order as products are put in, view products by each product category, and view products along with other shopping malls.

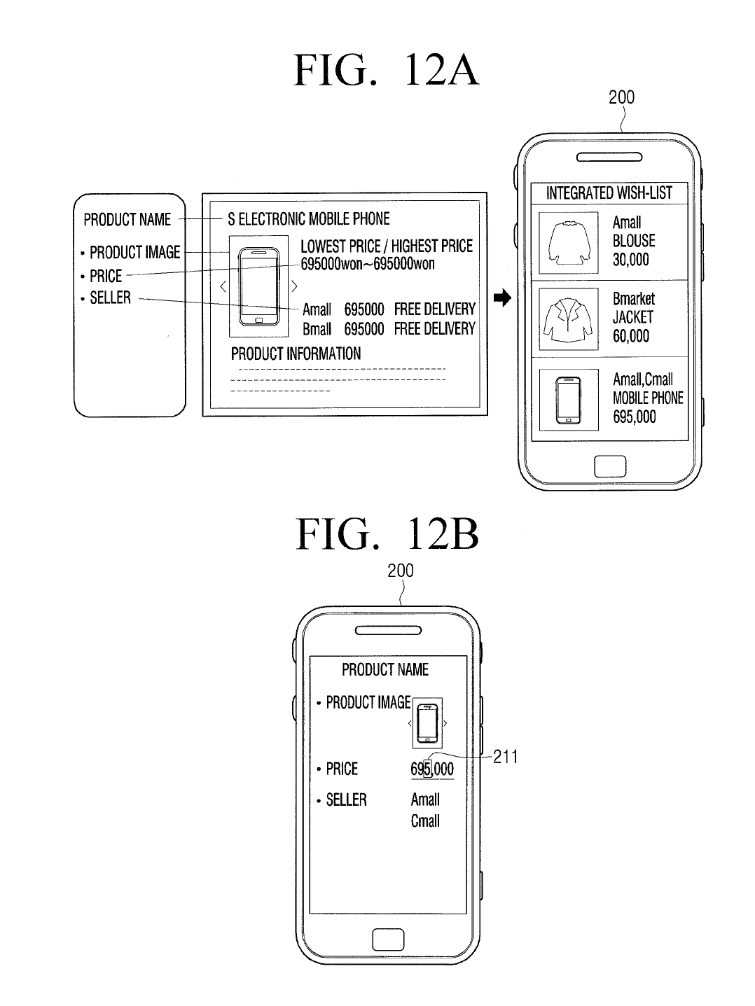

FIGS. 12A and 12B illustrate a method for storing information in an integrated wish-list according to an embodiment of the present disclosure.

Referring to the left portion of FIG. 12A, a specific web page is entered into and a specific product is selected while the integrated wish-list application is executed, and the corresponding product information may be extracted from the corresponding web page automatically and stored in the wish-list. Herein, the web page may be a shopping mall page, a product advertisement page, a product review page, and so on.

In this case, a product may be selected through a click manipulation of the integrated wish-list icon.

For example, product information corresponding to a preset item may be extracted from the corresponding web page automatically and stored in the integrated wish-list. That is, when items to be stored in the integrated wish-list are set to be a product image, a price, and a seller, text corresponding to the product image, the price, and the seller may be extracted from the corresponding web page and the extracted text may be matched to the corresponding items and stored. In this case, an existing method of extracting texts and images may be used.

When contents corresponding to all items are extracted and input from the corresponding web page, information regarding the corresponding product may be added to the integrated wish-list as illustrated in the right portion of FIG. 12A.

Referring to FIG. 12B, if an error occurs during an input of each item due to automatic extraction, a user may correct the error through a menu. For example, if the price of a product is erroneously input as 690,000 when it should be input as 695,000, a user may edit the item by executing the menu to correct an error item.

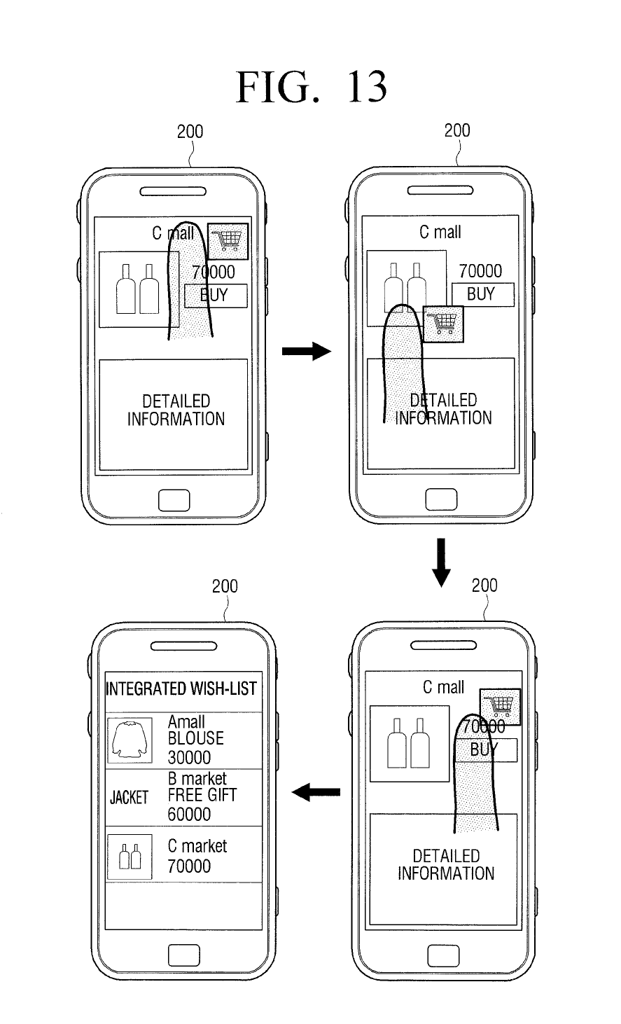

FIG. 13 illustrates a method for storing information in an integrated wish-list according to another embodiment of the present disclosure.

Referring to FIG. 13, a specific web page may be entered into while the integrated wish-list application is executed, and information selected by a user from among information provided on the web page may be added to the integrated wish-list.

As illustrated in FIG. 13, when a user selects the text of “Cmall”, the image of “cosmetic”, and the text of “70000” in sequence, only the corresponding information may be recorded in the integrated wish-list. Accordingly, if different information is selected from different shopping malls, various types of product information may be included in the integrated wish-list.

Meanwhile, a user may directly input product name or product image to add the product name or product image to the integrated wish-list. In this case, the product information may be obtained by web-searching the input product name or product image.

In addition, it is possible to perform web-searching using product tag barcode scan information.

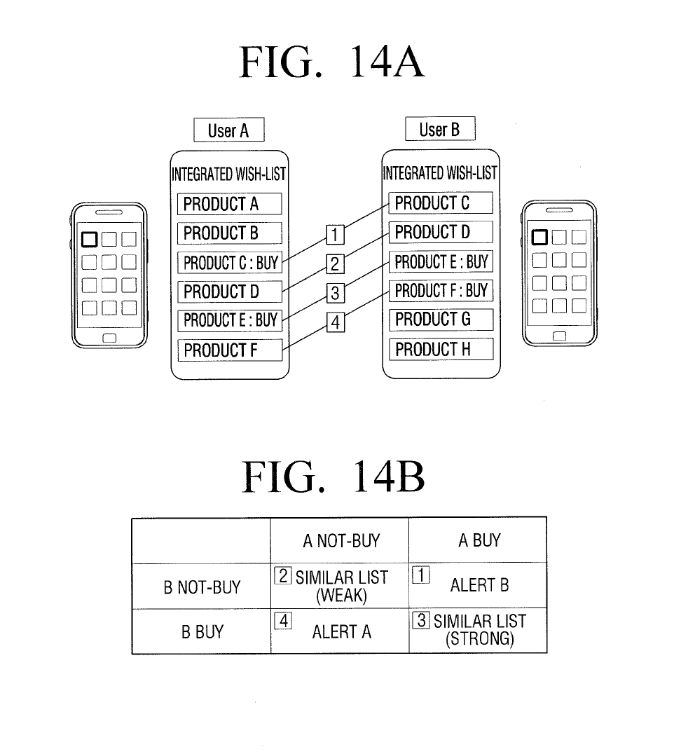

FIGS. 14A and 14B illustrate a method for comparing lists according to an embodiment of the present disclosure.

Referring to FIG. 14A, the integrated wish-list of user A and the integrated wish-list of user B may be compared to extract information to be provided. In this case, a purchase history may be stored in the integrated wish-list, but in some cases, information regarding purchased products may be stored and managed in a separate list.

As illustrated in FIG. 14A, it is noted that product A, product B, product C, product D, product E, and product F are stored in the integrated wish-list of user A, and product C and product E are recorded as purchased products. Further, it is noted that product C, product D, product E, product F, product G, and product H are stored in the integrated wish-list of user B, and product E is recorded as a purchased product.

That is, products, C, D, E, and F stored in the integrated wish-list of user A are also stored in the integrated wish-list of user B. In this case, the result of comparison of products C, D, E, and F is illustrated in FIG. 14B.

Referring to FIG. 14B, the products which both user A and user B have not purchased, that is, product D (2) is determined to have weak similarity, and the products that both user A and user B have purchased, that is, product E (3) is determined to have strong similarity. However, as product D and product E are products that both user A and user B either have or have not purchased, a separate alarm message is not provided.

Regarding product C, which is purchased by user A but not by user B, an alarm message informing that user A has purchased the corresponding product may be provided to user B.

Regarding product F, which is purchased by user B but not by user A, an alarm message informing that user A has purchased the corresponding product may be provided to user A.

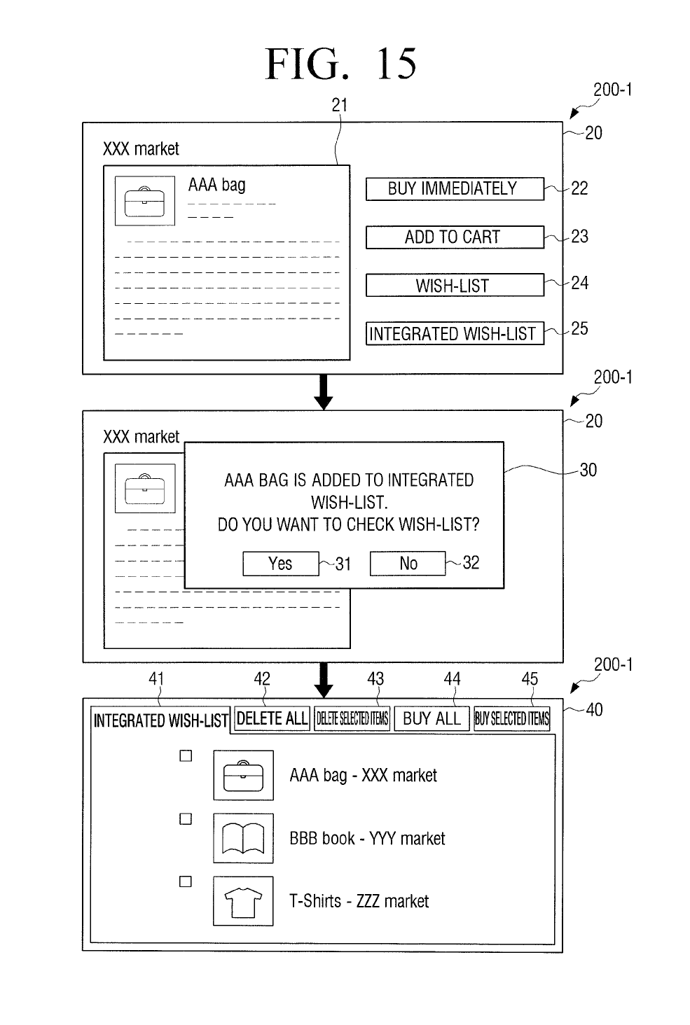

FIG. 15 illustrates a change of screen display status in the first user terminal device for selecting a product according to an embodiment of the present disclosure.

Referring to FIG. 15, the first user terminal device 200-1 displays the web page provided by a web server. The web page 20 displays an information area 21 where product information is displayed, a purchase menu 22 for purchasing, and menus 23, 24, 25 for registering products of interest. In FIG. 15, the cart 23, the wish-list 24, and the integrated wish-list 25 are displayed as menus for registering products of interest. Herein, the cart 23 and the wish-list 24 are menus for a list of individual products of interest where only products selected on the current web page 20 are registered as products of interest. On the other hand, the integrated wish-list 25 is an integrated wish-list menu where products which were selected previously from other web pages or products which will be selected later are registered in an integral manner.

As illustrated in FIG. 15, when a user selects a specific product and selects the integrated wish-list menu 25, a pop-up window 30 is displayed on the screen where the web page 20 is displayed. The pop-up window 30 may display the contents informing that the product is added to the integrated wish-list and inquiring whether to check the integrated wish-list. In addition, the pop-up window 30 may include menus 31 and 32 to approve or disapprove adding the product of interest to a wish-list.

When a user selects the menu 31 to approve checking of a wish-list, a list 41 of products which are recorded in the integrated wish-list may be displayed. In addition, delete menus 42 and 43 to delete products recorded in the integrated wish-list and purchase menus 44 and 45 to purchase products recorded in the integrated wish-list may be displayed.

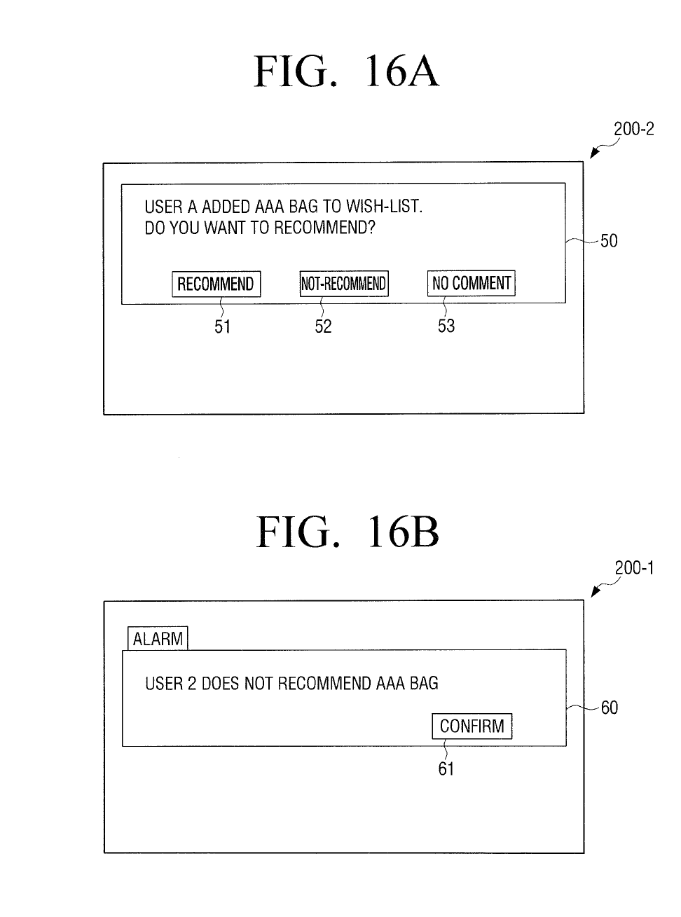

FIGS. 16A, 16B, 17A, 17B, and 18 illustrate example screens of the user terminal devices according to various embodiments of the present disclosure.

Referring to FIG. 16A, a message informing that the first user added AAA bag to the wish-list may be displayed on the screen of the second user terminal device 200-2 along with a pop-up window 50 including various menus such as recommend 51, not-recommend 52, and no comment 53. The second user may select one of the above menus. When the user selects the recommend menu 51 or the not-recommend menu 52, the corresponding evaluation information is transmitted to the network server apparatus 100.

FIG. 16B illustrates an example of a screen displayed on the first user terminal device 200-1 when evaluation information is input through the screen of FIG. 16A.

Referring to FIG. 16B, when the not-recommend menu 52 is selected in FIG. 16A, a pop-up window 60 including an evaluation information message informing that the corresponding product is not recommended is displayed on the first user terminal device 200-1. When a user checks the corresponding message, the user may delete the pop-up window 60 by selecting a confirm menu 61.

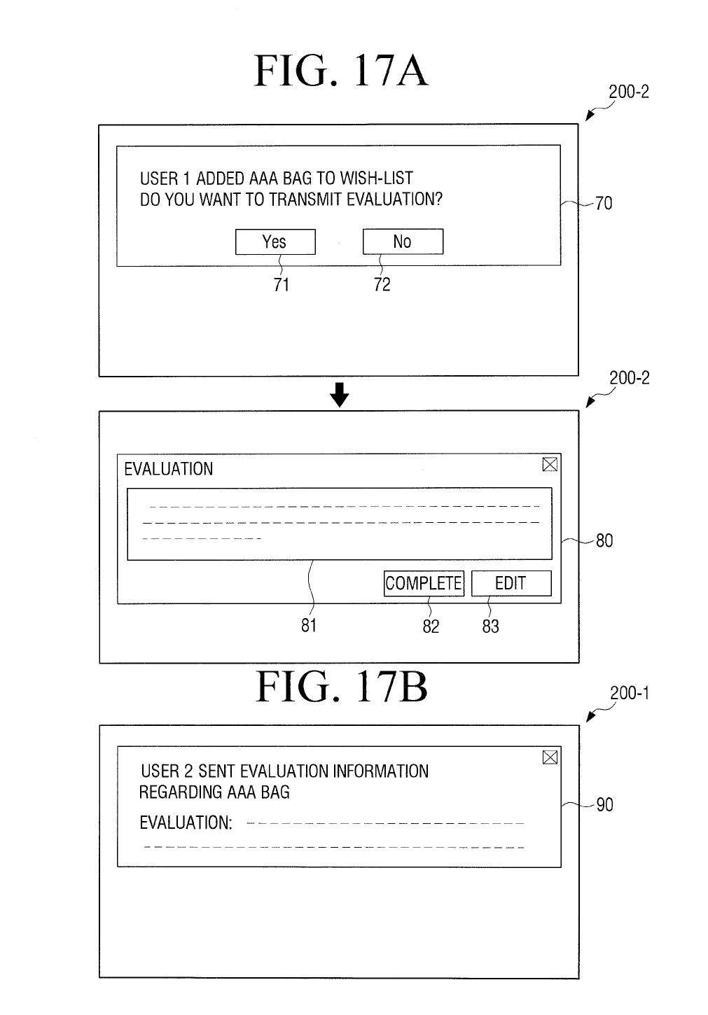

FIG. 17A illustrates another example of a screen of the second user terminal device 200-2 of the second user who has purchased the same product.

Referring to FIG. 17A, a message informing that the first user added AAA bag to the wish-list may be displayed on the screen of the second user terminal device 200-2 along with a pop-up window 70 inquiring whether to transmit evaluation. In this case, the pop-up window 70 may include menus to approve 71 or disapprove 72 transmitting of the evaluation.

The second user may select one of the above menus. When the user selects the menu to approve 71 transmitting of evaluation, an input window 81 to input evaluation and other menus regarding input of evaluation, for example, menus to complete 82 or edit 81 the evaluation may be displayed.

FIG. 17B illustrates an example of a screen displayed on the first user terminal device 200-1 when evaluation is input through the screen of FIG. 17A.

Referring to FIG. 17B, the evaluation that the second user has transmitted may be displayed on the screen of the first user terminal device 200-1 along with an alarm message informing that the second user has transmitted evaluation information.

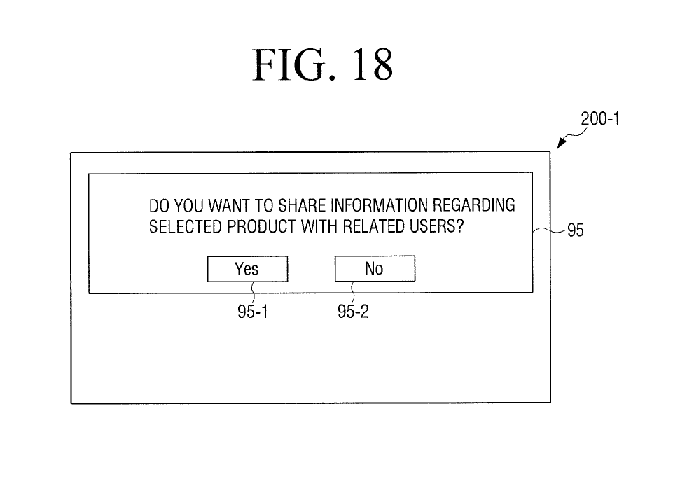

FIG. 18 illustrates another example of a screen displayed on the first user terminal device 200-1 which selects a specific product.

Referring to FIG. 18, when user selects a specific product and adds the product to a wish-list, a pop-up window 95 inquiring whether to share information regarding the corresponding product with other related users is displayed on the screen of the first user terminal device 200-1. In this case, the pop-up window 95 may include menus to approve 95-1 or disapprove 95-2 sharing of the information.

Meanwhile, when the first user selects the menu 95-1 to approve sharing of information, the screen illustrated in FIGS. 16A and 17A may be displayed on the second user terminal device 200-2.

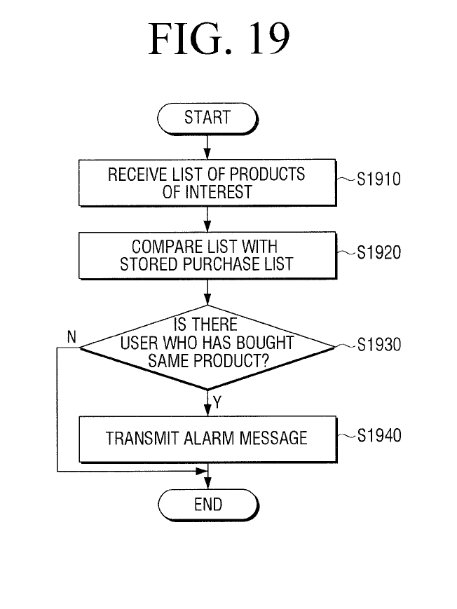

FIG. 19 is a flowchart of a method for providing information in a network server apparatus according to an embodiment of the present disclosure.

Referring to FIG. 19, a list of products of interest of the first user is initially received at operation S1910.

Subsequently, a purchase list of a pre-registered user is compared with the list of products of interest, and the second user who has purchased a product recorded in the list of products of interest is searched at operation S1920.

When the second user who has purchased the same product as the product recorded in the list of products of interest of the first user at operation S1930, an alarm message is transmitted to the user terminal of at least one of the first user and the second user at operation S1940.

In addition, when evaluation information regarding the product is received from the user terminal device of the second user based on the alarm message transmitted to the user terminal device of the second user, the evaluation information may be transmitted to the user terminal device of the first user.

Meanwhile, at operation S1940, a message to inquire whether to share information may be transmitted to the user terminal device of the first user, and when a signal to approve sharing of information is received from the user terminal device of the first user, an alarm message may be transmitted to the user terminal device of the second user. In this case, the alarm message may be a message to request the input of recommendation information of the product.

When the list of products of interest of the first user is received, a message signal to inquire whether to share information may be transmitted to the user terminal device of the first user. In this case, the second user may be searched when a signal to approve sharing of information is received from the user terminal device of the first user.

In this case, the list of products of interest may be an integrated wish-list in which information regarding products selected from each of a plurality of different web pages is listed in an integral manner.

Meanwhile, at operation S1920, users related to the first user from among pre-registered entire users may be searched. In addition, a purchase list including a product in the list of products of interest from among the purchase lists of the searched related users may be searched, and the user of the searched purchase list may be determined to be the second user.

In this case, the purchase list and the list of products of interest may be shared among related users.

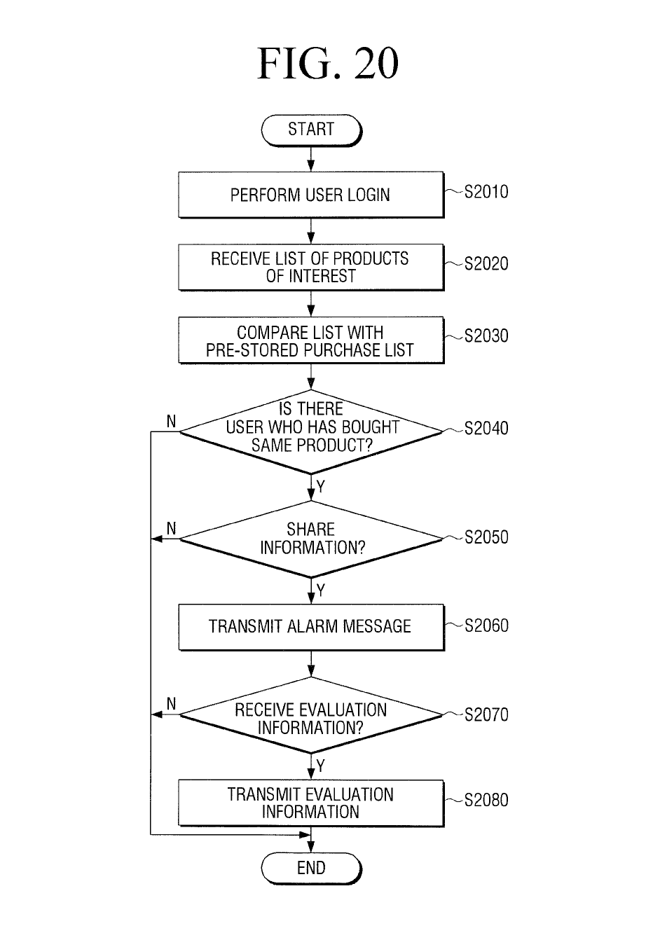

FIG. 20 is a flowchart of a method for providing information in a network server apparatus according to an embodiment of the present disclosure.

Referring to FIG. 20, when the first user logs into a network server at operation S2010, the list of products of interest of the first user is received at operation S2020.

Subsequently, the purchase list of a pre-registered user is compared with the list of products of interest, and the second user who has purchased the product in the list of products of interest is searched at operation S2030.

When the second user has purchased the same product as the product recorded in the list of products of interest of the first user is searched at operation S2040, a message signal to inquire whether to share information with the second user may be transmitted to the user terminal device of the first user at operation S2050.

When a signal to approve sharing information is received from the first user at operation S2050, an alarm message is transmitted to the user terminal device of the second user at operation S2060.

Subsequently, when evaluation information regarding the corresponding product is received from the user terminal device of the second user at operation S2070, the received evaluation information is transmitted to the user terminal device of the first user at operation S2080.

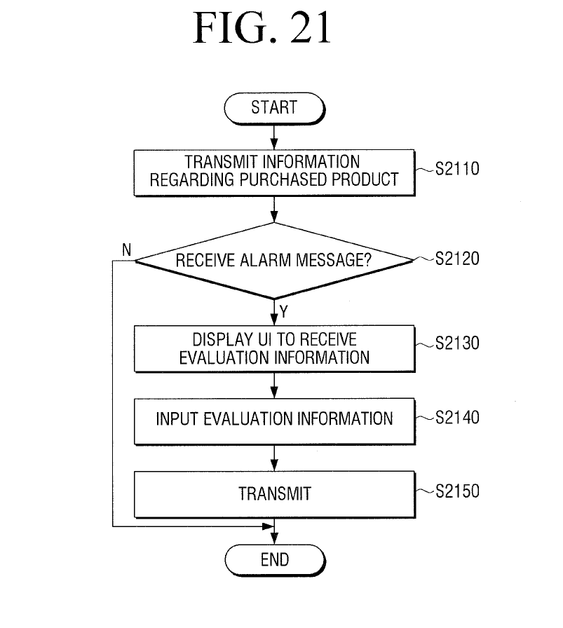

FIG. 21 is a flowchart of a method for providing evaluation information regarding a product of interest of other user according to an embodiment of the present disclosures.

Referring to FIG. 21, information regarding a purchased product is transmitted to a network server apparatus at operation S2110.

Subsequently, when an alarm message is received from the network server apparatus at operation S2120, a UI to receive evaluation information regarding the purchased product is displayed at operation S2130. In this case, when the purchased product is included in the integrated wish-list of other users, the network server apparatus may transmit an alarm message.

When evaluation information is input on the displayed UI at operation S2140, the input evaluation information is transmitted to the network server apparatus at operation S2150.

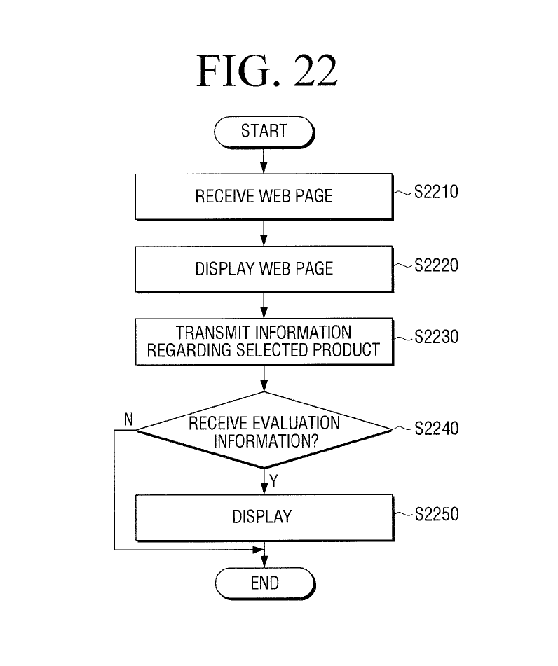

FIG. 22 is a flowchart of a method for receiving evaluation information from other users regarding a product of interest according to an embodiment of the present disclosure.

Referring to FIG. 22, when a web page is received from a web server at operation S2210, the received web page is displayed at operation S2220.

Subsequently, when a product is selected on the web page, the selected product is included in the integrated wish-list and transmitted to the network server apparatus at operation S2230.

Subsequently, when evaluation information of another user who has purchased the product included in the integrated wish-list is received at operation S2240, the received evaluation information is displayed at operation S2250.

Meanwhile, the user terminal device of another user may transmit information regarding the product which is purchased by another user to the network server apparatus. Subsequently, when an alarm message informing that there is an integrated wish-list including the purchased product is received from the network server apparatus, the user terminal device of another user displays a UI to receive evaluation information regarding the purchased product. Subsequently, when evaluation information is input on the displayed UI, the input evaluation information is transmitted to the network server apparatus.

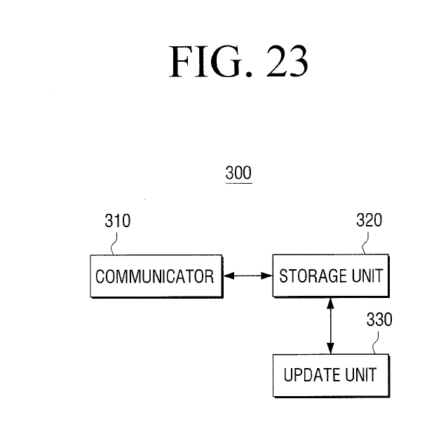

FIG. 23 is a view block diagram of a database server according to an embodiment of the present disclosure.

Referring to FIG. 23, a database server 300 comprises a communicator 310, a storage unit 320, and an update unit 330.

The communicator 310 performs communication with an external apparatus.

Specifically, the communicator 310 may perform communication with an external user terminal device and receive a purchase history from the external user terminal device. In this case, the external user terminal device may be a terminal of a user who is pre-registered in the database server.

In addition, the communicator 310 may further receive a list of products of interest from the external user terminal apparatus.

The storage unit 320 stores a purchase history of a pre-registered user. Herein, the purchase history may include not only information regarding whether a product is purchased but also when it was purchased, how it was purchased, how much it cost, and so on.

In addition, the storage unit 320 may store relationship among registered users. For example, whether the relationship between user A and user B is family, friend, or colleague may be stored based on user login information, SNS relation information, and so on. Accordingly, in consideration of the user relationship, evaluation information may be requested to other users.

Further, the storage unit 320 may store a list of products of interest of pre-registered users.

When purchase information of pre-registered users is received from an external apparatus, the update unit 330 updates the stored purchase history based on the received purchase information.

In addition, when a list of products of interest is received from an external apparatus, the update unit 330 may update the pre-stored list of products of interest.

Further, the update unit 330 may update relationship of pre-stored users. In this case, when user information is polled on the SNS server, etc. or new information is received periodically, the update unit 330 may update the user information according to a preset event.

Meanwhile, the method for providing information in a network server apparatus and the method for providing evaluation information in a user terminal device according to various embodiments may be realized as a program module and provided to the network server apparatus or the user terminal device.

For example, a non-transitory computer readable medium which stores program receiving a list of products of interest of the first user, comparing a purchase list of a pre-registered user with the list of products of interest, searching the second user who has purchased a product recorded in the list of products of interest, and when the second user is searched, notifying the search to the user terminal device of at least one of the first user and the searched second user may be provided.

The non-transitory recordable medium refers to a medium which may store data semi-permanently rather than storing data for a short time such as a register, a cache, and a memory and may be readable by an apparatus. Specifically, the above-mentioned various applications or programs may be stored in a non-temporal recordable medium such as CD, DVD, hard disk, Blu-ray disk, USB, memory card, and ROM and provided therein.

While the present disclosure has been shown and described with reference to various embodiments thereof, it will be understood by those skilled in the art that various changes in form and details may be made therein without departing from the spirit and scope of the present disclosure as defined by the appended claims and their equivalents.

What is claimed is:

1. A network server apparatus comprising:
a storage unit configured to store a purchase list of a pre-registered user;
a communicator configured to receive a list of products of interest of a first user;
a searcher configured to compare a purchase list stored in the storage unit with the list of products of interest and identify a second user who has purchased a product recorded in the list of products of interest; and
a controller configured to, when the second user is identified, notify that the second user is identified to a user terminal device of one of the second user and the first user.

2. The network server apparatus of claim 1, wherein the controller, when evaluation information of the product is received from the terminal apparatus of the second user, controls the communicator to transmit the evaluation information to the terminal device of the first user.

3. The network server apparatus of claim 2, wherein the controller, when the second user is identified, controls the communicator to transmit a message signal inquiring whether to share information to the terminal device of the first user, when a signal to approve sharing of information is received from the terminal device of the first user, to transmit an alarm message to the terminal device of the second user, and when a signal to disapprove sharing of information is received from the terminal device of the first user or a signal to approve sharing of information is not received for a predetermined time, not to transmit the alarm message,
wherein the alarm message is a message to request an input of recommendation information of the product.

4. The network server apparatus of claim 2, wherein the controller, when the list of products of interest of the first user is received, controls the searcher to transmit a message signal inquiring sharing of information to the terminal device of the first user, and when a signal to approve sharing of information is transmitted from the terminal apparatus of the first user, to identify the second user.

5. The network server apparatus of claim 1, wherein the list of products of interest is a list of information of products that are selected from different web pages.

6. The network server apparatus of claim 1, wherein the searcher searches users related to the first user from among all pre-registered users, and identifies the second user from among the searched related users.

7. The network server apparatus of claim 1, wherein the purchase list stored in the storage unit and the list of products of interest are sharable among related users.

8. A method for providing information in a network server apparatus, the method comprising:
receiving a list of products of interest of a first user;
comparing a purchase list of a related user with the list of products of interest and identifying a second user who has purchased a product recorded in the list of products of interest; and
when the second user is identified, notifying that the second user is identified to a user terminal device of one of the second user and the first user.

9. The method of claim 8, further comprising:
when evaluation information of the product is received from the terminal apparatus of the second user, transmitting the evaluation information to the terminal device of the first user.

10. The method of claim 9, wherein the notifying comprises:
transmitting a message signal inquiring whether to share information to the terminal device of the first user; and
when a signal to approve sharing of information is received from the terminal device of the first user, transmitting an alarm message to the terminal device of the second user,
wherein the alarm message is a message to request an input of recommendation information of the product.

11. The method of claim 9, further comprising:
when the list of products of interest of the first user is received, transmitting a message signal inquiring sharing of information to the terminal device of the first user,
wherein the second user is searched when a signal to approve sharing of information is transmitted from the terminal apparatus of the first user.

12. The method of claim 8, wherein the list of products of interest is a list where information of products that are selected from different web pages.

13. The method of claim 8, wherein the identifying of the second user comprises:
searching users related to the first user from among all pre-registered users; and
searching a purchase list including a product in the list of products of interest from purchase lists of the searched related users and determining a user corresponding to the searched purchase list as the second user.

14. The method of claim 8, wherein the purchase list stored in the storage unit and the list of products of interest are sharable among related users.

15. A user terminal device comprising:
a communicator configured to transmit information of a purchased product to a network server apparatus, and when the purchased product is included in a list of products of interest of another user, receive an alarm message from the network server apparatus;
a display configured to display a User Interface (UI) to receive evaluation information of the purchased product when the alarm message is received; and
a controller configured to, when the evaluation information is input on the UI, transmit the evaluation information to the network server apparatus.

16. A method for providing evaluation information in a user terminal device, the method comprising:
transmitting information of a purchased product to a network server apparatus;
when the purchased product is included in a list of products of interest of another user, receiving an alarm message from the network server apparatus;
when the alarm message is received, displaying a User Interface (UI) to receive evaluation information of the purchased product; and
when the evaluation information is input on the UI, transmitting the evaluation information to the network server apparatus.

17. A user terminal device comprising:
a communicator configured to receive a web page from a web server;
a display configured to display the web page; and
a controller configured to control the communicator to include a product selected on the web page in a list of products of interest and transmit the list to the communicator,
wherein the controller, when evaluation information of another user who has purchased a product included in the list of products of interest is received from the network server apparatus, controls the display to display the evaluation information.

18. A method for providing evaluation information in a user terminal device, the method comprising:
receiving a web page from a web server;
displaying the web page;
when a product is selected on the web page, including the selected product in a list of products of interest and transmitting the list to a network server apparatus;
receiving evaluation information of another user who has purchased a product included in the list of products of interest from the network server apparatus; and
displaying the evaluation information.

19. The method of claim 18, comprising:
transmitting information of a product purchased by a user of the user terminal device to the network server apparatus;
when an alarm message informing that there is a list of products of interest including the purchased product is received from the network server apparatus, displaying a User Interface (UI) to receive evaluation information of the purchased product;
when the evaluation information is input on the UI, transmitting the evaluation information to the network server apparatus.

20. A database server comprising:
a communicator configured to perform communication with an external apparatus;
a storage unit configured to store a purchase history of a pre-registered user; and
an update unit configured to, when purchase information of the pre-registered user is received from the external apparatus, update the stored purchased history based on the received purchase information.
